(19) United States
(12) Patent Application Publication
(10) Pub. No.: US 2013/0042063 A1
(43) Pub. Date: Feb. 14, 2013

(54) SYSTEM AND METHOD FOR CONTROLLING DUAL MEMORY CARDS

(71) Applicant: TAO-LIANG LI, Shenzhen City (CN)

(72) Inventor: TAO-LIANG LI, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/204,733

(22) Filed: Aug. 8, 2011

(51) Int. Cl. G06F 12/00

(52) U.S. Cl. 711/115; 711/E12.001

(57) ABSTRACT

A system and method controls dual memory cards of an electronic device. The electronic device includes a first memory card and a second memory card. The method sets a first trigger command for connecting the first memory card to a processor, and a second trigger command for connecting the second memory card to the processor. The first memory card is set as a default memory card to connect to the processor. If the electronic device has received the second trigger command, the method controls a processor to communicate with the second memory card through an analog switch and a second connector. If the electronic device has received the first trigger command, the method further controls the processor to communicate with the first memory card through the analog switch and a first connector.

### BACKGROUND

1. Technical Field

Embodiments of the present disclosure relate to systems and methods of memory card control, and more particularly to a system and method for controlling dual memory cards of an electronic device.

2. Description of Related Art

Storage capacity of an electronic device is very important. The electronic device may use an external memory card to extend the storage capacity of the electronic device, such as, using a Secure Digital (SD) Card, or a Trans Flash (TF) card, for example. The capacity of one external memory card may be 2 GB, 4 GB, or 16 GB. If the electronic device requires more storage capacity, a memory card in the electronic device may not be enough for the requirement of the electronic device.

### BRIEF DESCRIPTION OF THE DRAWINGS

FIG. 1 is a schematic diagram of a first embodiment of an electronic device.

FIG. 2 is a schematic diagram of a second embodiment of an electronic device including a control system.

FIG. 3 is a block diagram of one embodiment of the control system included in an electronic device of FIG. 2.

FIG. 4 is a flowchart of one embodiment of a method for controlling dual memory cards of an electronic device, such as, that of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

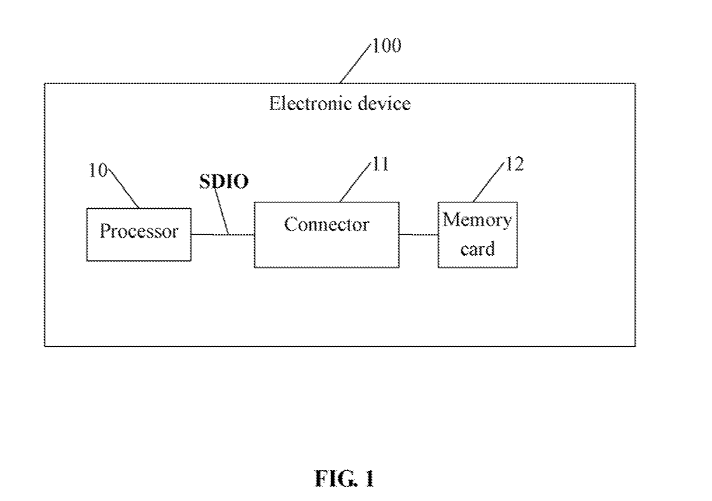

FIG. 1 is a schematic diagram of a first embodiment of an electronic device 100. The electronic device 100 includes a processor 10, a connector 11 and a memory card 12. The processor 10 connects to the connector 11 through a Secure Digital Input and Output Card (SDIO) interface, and the connector 11 connects to the memory card 12. The connector 11 is a memory card connector. The memory card 12 may store various data of the electronic device 1. The electronic device 1 may use the memory card 12 to extend the storage capacity of the electronic device 1.

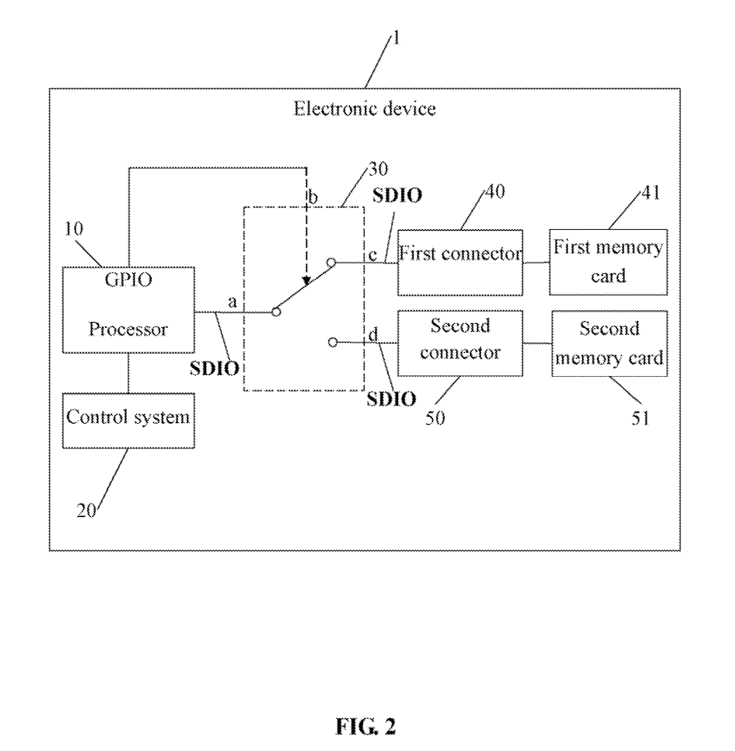

FIG. 2 is a schematic diagram of a second embodiment of an electronic device 1 including a control system 20. As mentioned, the electronic device 1 includes the processor 10 that executes one or more computerized codes and other applications of the electronic device 1, to provide functionality to the electronic device 1. In the embodiment, the electronic device 1 includes an analog switch 30, a first connector 40, a first memory card 41, a second connector 50 and a second memory card 51. The control system 20 may use the analog switch 30 to switch between use of the first memory card 41 and the second memory card 51. Therefore, the electronic device 1 use both of the first memory card 41 and the second memory card 51 to extend the capacity of the electronic device 1. Detailed descriptions are provided as follows.

The analog switch 30 may have an input port (denoted as input port “a”), a control port (denoted as control port “b”), a first output port (denoted as first output port “c”), and a second output port (denoted as second output port “d”). The input port “a” may set to connect the first output port “c”, if a first voltage is output to the control port “b”. The input port “a” may set to connect the second output port “d”, if a second voltage level is output to the control port “b”. In one embodiment, the first voltage level may be a high voltage for connecting the input port “a” to the first output port “c”. The second voltage level may be a low voltage for connecting the input port “a” to the second output port “d”. The high voltage may be defined as 1V (logic 1), and the low voltage may be defined as 0V (logic 0), for example.

In the embodiment, the input port “a” connects to the processor 10 through the SDIO interface. The processor 10 may include a general-purpose input/output (GPIO) pin. The control port “b” connects to the GPIO pin of the processor 10. The first output port “c” connects to the first connector 40 through the SDIO interface, and the second output port “d” connects to the second connector 50 through the SDIO interface.

The first connector 40 is configured to be connected with the first memory card 41. The second connector 50 is configured to be connected with the second memory card 51. The first memory card 41 and the second memory card 51 may store various data of the electronic device 1. The first memory card 41 and the second memory card 51 may be Secure Digital (SD) Cards, Trans Flash (TF) cards, and other memory cards supporting the SDIO interface.

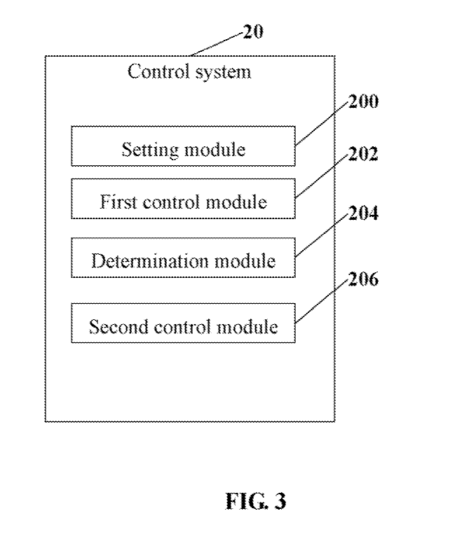

FIG. 3 is a block diagram of one embodiment of the control system 20 included in the electronic device 1 of FIG. 2. In the embodiment, the control system 20 may include a setting module 200, a first control module 202, a determination module 204, and a second control module 206. The modules 200, 202, 204, and 206 comprise computerized codes in the form of one or more programs that are stored in a storage system, such as the first memory card 41 or the second memory card 51 of the electronic device 1. The computerized code includes instructions that are executed by at least one processor 10 to provide functions for the modules. Details of these operations are as follows.

The setting module 200 sets a first trigger command for connecting the first memory card 41 to the processor 10, and sets a second trigger command for connecting the second memory card 51 to the processor 10. In one embodiment, the setting module 200 may set a first virtual icon of the first memory card 41, and a second virtual icon of the second memory card 51. The first virtual icon and the second virtual icon may be displayed on a display (not shown in FIG. 2) of the electronic device 1. When the first virtual icon is clicked or is selected, the first memory card 41 may be connected to the processor 10 according to the first trigger command. When the second virtual icon is clicked or is selected, the second memory card 51 may be connected to the processor 10 according to the second trigger command. Users may click or select one of the two virtual icons to determine a memory card to be operated.

The setting module 200 further sets the first memory card 41 as a default memory card to connect the processor 10 when the electronic device 1 starts up. In one embodiment, the setting module 200 may set the GPIO pin to output the first voltage level when operating the first memory card 41. The input port “a” of the analog switch 30 may connect to the first output “c”, thus the processor 10 can communicate with the first memory card 41 through the analog switch 30 and the first connector 40.

The first control module 202 controls the processor 10 to communicate with the second memory card 51 through the analog switch 30 and the second connector 50, if the electronic device 1 has received the second trigger command. The users can operate the second memory card 51. In the embodiment, the first control module 202 may control the processor 10 to generate the second voltage level when operating the second memory card 51, and then sends the second voltage level to the control port “b” of the analog switch 30, to control the input port “a” to connect to the second output “d”.

The determination module 204 determines whether the electronic device 1 has received the first trigger command. Upon the condition that the electronic device 1 has received the first trigger command, the second control module 206 controls the processor 10 to communicate with the first memory card 41 through the analog switch 30 and the first connector 40. In the embodiment, the second control module 206 may control the processor 10 to generate the first voltage level when operating the first memory card 41, and then sends the first voltage level to the control port “b” of the analog switch 30, to control the input port “a” to connect to the first output “c”.

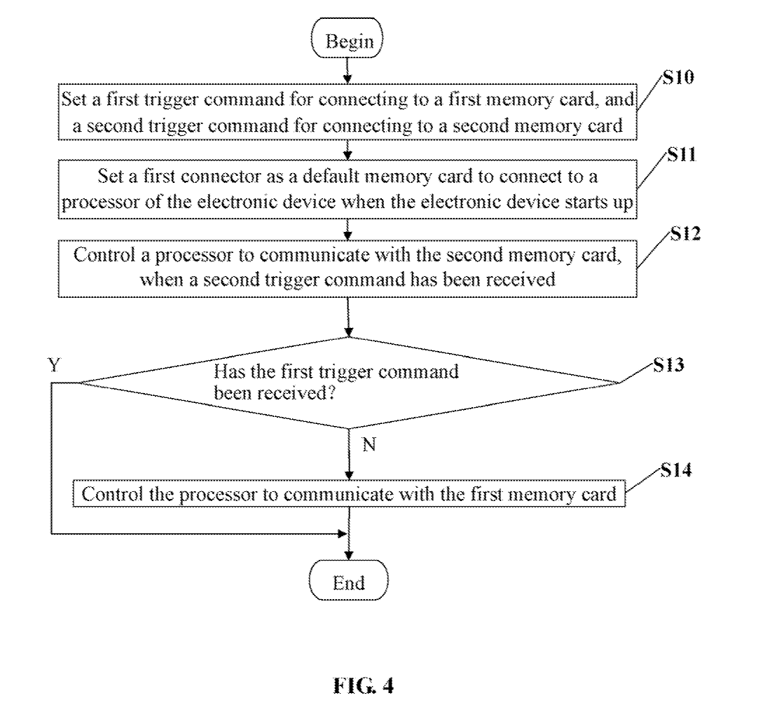

FIG. 4 is a flowchart of one embodiment of a method for controlling dual memory cards of an electronic device, such as, that of FIG. 2. Depending on the embodiment, additional blocks may be added, others deleted, and the ordering of the blocks may be changed.

In block S10, the setting module 200 sets a first trigger command for connecting the first memory card 41 to the processor 10, and sets a second trigger command for connecting the second memory card 51 to the processor 10. In one embodiment, the setting module 200 may set a first virtual icon of the first memory card 41, and a second virtual icon of the second memory card 51. The first virtual icon and the second virtual icon may be displayed on a display (not shown in FIG. 2) of the electronic device 1. When the first virtual icon is clicked or is selected, the first memory card 41 may be connected to the processor 10 according to the first trigger command. When the second virtual icon is clicked or is selected, the second memory card 51 may be connected to the processor 10 according to the second trigger command. Users may click or select one of the two virtual icons to determine a memory card to be operated.

In block S11, the setting module 200 sets the first memory card 41 as a default memory card to connect the processor 10 when the electronic device 1 starts up. In the embodiment, the setting module 200 may set the GPIO pin to output the first voltage level when operating the first memory card 41. The input port “a” of the analog switch 30 may connect to the first output “c”, and the processor 10 can communicate with the first memory card 41 through the analog switch 30 and the first connector 40.

If the electronic device 1 has received the second trigger command, in block S12, the first control module 202 controls the processor 10 to communicate with the second memory card 51 through the analog switch 30 and the second connector 50. In one embodiment, the first control module 202 may generate the second voltage level when operating the second memory card 51, and then sends the second voltage level to the control port “b” of the analog switch 30, to control the input port “a” to connect to the second output “d”.

In block S13, the determination module 204 determines whether the electronic device 1 has received the first trigger command. If the electronic device 1 has received the first trigger command, block S14 is implemented. Otherwise, if the electronic device 1 has not received the first trigger command, the procedure ends.

In block S14, the second control module 206 controls the processor 10 to communicate with the first memory card 41 through the analog switch 30 and the first connector 40. In the embodiment, the second control module 206 may generate the first voltage level when operating the first memory card 41, and then sends the first voltage level to the control port “b” of the analog switch 30, to control the input port “a” to connect to the first output “c”.

It should be emphasized that the described exemplary embodiments are merely possible examples of implementations, and have been set forth for a clear understanding of the principles of the present disclosure. Many variations and modifications may be made to the-described exemplary embodiments without departing substantially from the spirit and principles of the present disclosure. All such modifications and variations are intended to be included herein within the scope of this disclosure and the described inventive embodiments, and the present disclosure is protected by the following claims.

What is claimed is:

1. A method for controlling dual memory cards of an electronic device, the method comprising:
setting a first trigger command for connecting a first memory card of the electronic device to a processor of the electronic device, and a second trigger command for connecting a second memory card of the electronic device to the processor;
setting the first memory card as a default memory card to connect to the processor of the electronic device;
controlling the processor to communicate with the second memory card through an analog switch and a second connector of the electronic device, upon the condition that the electronic device has received the second trigger command;
determining whether the electronic device has received the first trigger command after the processor has communicated with the second memory card;
controlling the processor to communicate with the first memory card through the analog switch and a first connector of the electronic device, upon the condition that the electronic device has received the first trigger command.

2. The method as claimed in claim 1, wherein the analog switch comprises:
an input port that connects to the processor through a Secure Digital Input and Output Card (SDIO) interface;
a control port that connects to a general-purpose input/output (GPIO) pin of the processor;
a first output port that connects to the first connector through the SDIO interface; and
a second output port that connects to the second connector through the SDIO interface.

3. The method as claimed in claim 2, wherein the first connector connects to the first memory card, and the second connector connects to the second memory card.

4. The method as claimed in claim 2, further comprising:
sending a first voltage level to the control port of the analog switch through the GPIO pin, to control the processor to communicate with the first memory card; and
sending a second voltage level to the control port of the analog switch through the GPIO pin, to control the processor to communicate with the second memory card.

5. The method as claimed in claim 4, wherein the first voltage level is a high level voltage for connecting the input port to the first output port, and the second voltage level is a low level voltage for connecting the input port to the second output port.

6. The method as claimed in claim 5, wherein the high level voltage corresponds to logic 1, the low level voltage corresponds to logic 0.

7. A non-transitory storage medium storing a set of instructions, the set of instructions capable of being executed by a processor to perform a method for controlling dual memory cards of an electronic device, the method comprising:
setting a first trigger command for connecting a first memory card of the electronic device to a processor of the electronic device, and a second trigger command for connecting a second memory card of the electronic device to the processor;
setting the first memory card as a default memory card to connect to the processor of the electronic device;
controlling the processor to communicate with the second memory card through an analog switch and a second connector of the electronic device, upon the condition that the electronic device has received the second trigger command;
determining whether the electronic device has received the first trigger command, after the processor has communicated with the second memory card;
controlling the processor to communicate with the first memory card through the analog switch and a first connector of the electronic device, upon the condition that the electronic device has received the first trigger command.

8. The storage medium as claimed in claim 7, wherein the analog switch comprises:
an input port that connects to the processor through a Secure Digital Input and Output Card (SDIO) interface;
a control port that connects to a general-purpose input/output (GPIO) pin of the processor;
a first output port that connects to the first connector through the SDIO interface; and
a second output port that connects to the second connector through the SDIO interface.

9. The storage medium as claimed in claim 8, wherein the first connector connects to the first memory card, and the second connector connects to the second memory card.

10. The storage medium as claimed in claim 8, further comprising:
sending a first voltage level to the control port of the analog switch through the GPIO pin, to control the processor to communicate with the first memory card; and
sending a second voltage level to the control port of the analog switch through the GPIO pin, to control the processor to communicate with the second memory card.

11. The storage medium as claimed in claim 10, wherein the first voltage level is a high level voltage for connecting the input port to the first output port, and the second voltage level is a low level voltage for connecting the input port to the second output port.

12. The storage medium as claimed in claim 11, wherein the high level voltage corresponds to logic 1, the low level voltage corresponds to logic 0.

13. An electronic device, comprising:
a first memory card, a second memory card, an analog switch, a first connector, a second connector, and a processor; and
one or more programs that are stored in a storage system and are executed by the processor, the one or more programs comprising:
a setting module operable to set a first trigger command for connecting the first memory card to the processor, and a second trigger command for connecting the second memory card to the processor, and set the first memory card as a default memory card to connect to the processor of the electronic device;
a first control module operable to control the processor to communicate with the second memory card through the analog switch and the second connector, upon the condition that the electronic device has received the second trigger command;
a determination module operable to determine whether the electronic device has received the first trigger command, after the processor has communicated with the second memory card;
a second control module operable to control the processor to communicate with the first memory card through the analog switch and the first connector, upon the condition that the electronic device has received the first trigger command.

14. The electronic device as claimed in claim 13, wherein the analog switch comprises:
an input port that connects to the processor through a Secure Digital Input and Output Card (SDIO) interface;
a control port that connects to a general-purpose input/output (GPIO) pin of the processor;
a first output port that connects to the first connector through the SDIO interface; and
a second output port that connects to the second connector through the SDIO interface.

15. The electronic device as claimed in claim 14, wherein the first connector connects to the first memory card, and the second connector connects to the second memory card.

16. The electronic device as claimed in claim 14, wherein the first control module controls the processor to communicate with the first memory card by sending a first voltage level to the control port of the analog switch through the GPIO pin, and the second control module controls the processor to communicate with the second memory card by sending a second voltage level to the control port of the analog switch through the GPIO pin.

17. The electronic device as claimed in claim 16, wherein the first voltage level is a high level voltage for connecting the input port to the first output port, and the second voltage level is a low level voltage for connecting the input port to the second output port.

18. The electronic device as claimed in claim 17, wherein the high level voltage corresponds to logic 1, the low level voltage corresponds to logic 0.
